(19) United States
(12) Patent Application Publication
(10) Pub. No.: US 2025/0233197 A1
(43) Pub. Date: Jul. 17, 2025

(54) BATTERY

(71) Applicant: Sumitomo Chemical Co., Ltd, Tokyo (JP)

(72) Inventors: Thomas Johannes KUGLER, Godmanchester (GB); Helen BENJAMIN, Godmanchester (GB); Florence BOURCET, Godmanchester (GB)

(73) Assignee: Sumitomo Chemical Co., Ltd, Tokyo (JP)

(21) Appl. No.: 18/852,958

(22) PCT Filed: Mar. 30, 2023
(86) PCT No.: PCT/EP2023/058427

§ 371 Date: Sep. 30, 2024

(30) Foreign Application Priority Data
Mar. 31, 2022 (GB) 2204643.7

(51) Int. Cl. H01M 10/056

(52) U.S. Cl. CPC H01M 10/056; H01M 2300/0065

(57) ABSTRACT

A metal battery or metal ion battery comprising an anode, a cathode and a compound of formula (I) disposed between the anode and the cathode: wherein X is Al or B; Ar¹ in each occurrence is independently an unsubstituted or substituted arylene or heteroarylene group; Y is a divalent group; and M⁺ is a cation.

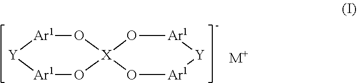

### BACKGROUND

Aluminate and borate compounds are known for a range of different applications.

CN101771166 discloses an ionic liquid electrolyte composed of certain organic lithium borate or lithium aluminate compounds and certain organic compound containing an amido functional group.

JP2004265785 discloses an ionic electrolyte material of formula (I):

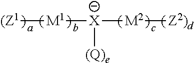

JP 2006/107793 discloses an ion having a fluorinated alkoxy group coordinated to a metallic element.

JP 2002/260734 discloses compounds of formula (I):

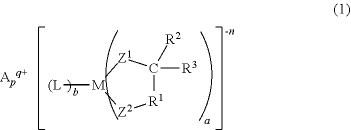

Soehner et al, “Halogen-free water-stable aluminates as replacement for persistent fluorinated weakly-coordinating anions”, Green Chem., 2014, 16, 4696-4707, discloses aluminates with an iridium metal complex cation.

Soehner et al, “Synthesis and structure of salts of a sterically shielded, lipophilic, C2-symmetric, fluxional aluminate”, ARKIVOC 2014 (iv) 296-318 discloses aluminate salts featuring ligands derived from a methan-2,2′-bisphenolate.

US 2009/247398 discloses olefin polymerisation catalysts having an anion comprising a metal atom bonded via heteroatoms to a chelating organic ligand and a cation comprising a Bronsted acid.

Sypien et al, “New aluminum 2,2′-methylenebis(4-chloro-3-methyl-6-(isopropyl)phenoxides): Structural characterization of an unusual ionic aluminum bisphenoxide [Al(THF)₄(Cl)₂]⁺[Al(mcmip)₂]⁻·x THF” discloses catalytic activity of the title compounds.

### SUMMARY

In some embodiments, the present disclosure provides a metal battery or metal ion battery comprising an anode, a cathode and a compound of formula (I) disposed between the anode and the cathode:

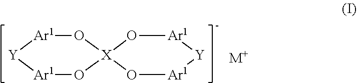

wherein X is Al or B; Ar¹ in each occurrence is independently an unsubstituted or substituted arylene or heteroarylene group; Y is a divalent group; and M⁺ is a cation.

Optionally, Ar¹ in each occurrence is independently a phenylene.

Optionally, Ar¹ in each occurrence is a 1,2-linked phenylene.

Optionally, one or more Ar¹ groups are substituted with at least one substituent R¹ selected from C₁₋₂₀ alkyl wherein one or more non-adjacent C atoms of the alkyl group may be replaced with O, S, NR³, CO, or COO wherein R³ is H or a substituent and one or more H atoms of the alkyl group may be replaced with F.

Optionally, Y is selected from O, S, NR³, C═O, CR²₂ and a branched or linear C₂₋₁₀ alkylene group wherein one or more non-adjacent C atoms may be replaced with O, S, NR³, CO or COO, wherein R² in each occurrence is independently H, F or a C₁₋₁₂ alkyl wherein one or more non-adjacent, non-terminal C atoms may be replaced with O, S, CO or COO and R³ in each occurrence is H or a substituent and one or more H atoms of the alkyl group may be replaced with F.

Optionally, M⁺ of the compound of formula (I) is an alkali metal ion, optionally a lithium ion.

Optionally, M⁺ is a solvated cation.

Optionally, the solvate is selected from solvents comprising at least one ether group and solvents comprising a carbonate group.

Optionally, the battery comprises no more than 20 moles of solvent per mole of M⁺.

Optionally, the battery is a metal battery.

### DESCRIPTION OF DRAWINGS

FIG. 1 is a schematic illustration of a battery according to some embodiments of the present disclosure having a separator comprising a compound as described herein;

FIG. 2 is a schematic illustration of a battery according to some embodiments of the present disclosure having an anode protection layer comprising a compound as described herein;

FIG. 3 is a ¹H NMR in THF-d8 of Compound Example 1 after drying

FIG. 4 is a ¹H NMR in THF-d8 of Compound Example 1 after 90 min exposure to moist air

FIG. 5 is a ¹H NMR in THF-d8 of Compound Example 1 after drying with one drop of water

FIG. 6 is a Diffusion Ordered Spectroscopy in THF-d8 of Compound Example 1 with one drop of water

FIG. 7 is a ¹H NMR in THF-d8 of Comparative Compound 1 after drying

FIG. 8 is a ¹H NMR in THF-d8 of Comparative Compound 1 after 60 min exposure to moist air

FIG. 9 shows Nyquist plot of the cells with electrolyte containing 1.0M of Compound Example 1 in propylene carbonate.

FIG. 10 shows Nyquist plot of the cells with electrolyte containing 2.0M of Compound Example 1 in propylene carbonate.

FIG. 11 shows Nyquist plot of the cells with electrolyte containing 3.0M of Compound Example 1 in propylene carbonate.

The drawings are not drawn to scale and have various viewpoints and perspectives. The drawings are some implementations and examples. While the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present. References to a layer “on” another layer when used in this application means that the layers are in direct contact. References to an element of the Periodic Table include any isotopes of that element.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

In some embodiments, the present disclosure provides a battery containing a compound of formula (I):

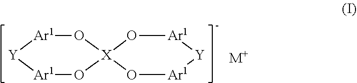

X is Al or B.
Ar¹ in each occurrence is independently an unsubstituted or substituted arylene or heteroarylene group.
Y is a divalent group.
M⁺ is a cation.

Preferably, Ar¹ in each occurrence is independently phenylene, more preferably a 1,2-linked phenylene; or a 6-membered heteroarylene in which ring atoms are C or N atoms, for example pyridine; 1,3-diazine, and 1,2,4-triazine.

Substituents of Ar¹, where present, are preferably selected from substituents R¹ wherein R¹ in each occurrence is independently selected from F or C₁₋₂₀ alkyl wherein one or more non-adjacent, non-terminal C atoms of the alkyl group may be replaced with O, S, NR³ wherein R³ is H or a substituent, CO or COO and one or more H atoms of the alkyl group may be replaced with F. Particularly preferred groups R¹ are F; C₁₋₁₂ alkyl; C₁₋₂₀ alkyl in which one or more non-adjacent, non-terminal C atoms are replaced with O; and partially fluorinated or perfluorinated C₁₋₁₂ alkyl.

By “non-terminal C atom” of an alkyl group as used herein is meant a C atom of the alkyl group other than the C atom of a methyl group or C atoms of methyl groups at the chain end or chain ends of a linear or branched alkyl, respectively.

R³ is preferably H or a C₁₋₁₂ alkyl group.

Preferably, Y is selected from O, S, NR³, C—O, CR²₂ and a branched or linear C₂₋₁₀ alkylene group wherein one or more non-adjacent C atoms may be replaced with O, S, CO or COO, and wherein R² in each occurrence is independently H, F or a C₁₋₁₂ alkyl wherein one or more non-adjacent, non-terminal C atoms may be replaced with O, S, NR³, CO or COO and one or more H atoms of the C₁₋₁₂ alkyl may be replaced with F·M⁺ of the compound of formula (I) is preferably an alkali metal ion, more preferably a lithium ion.

Exemplary compounds of formula (I) include:

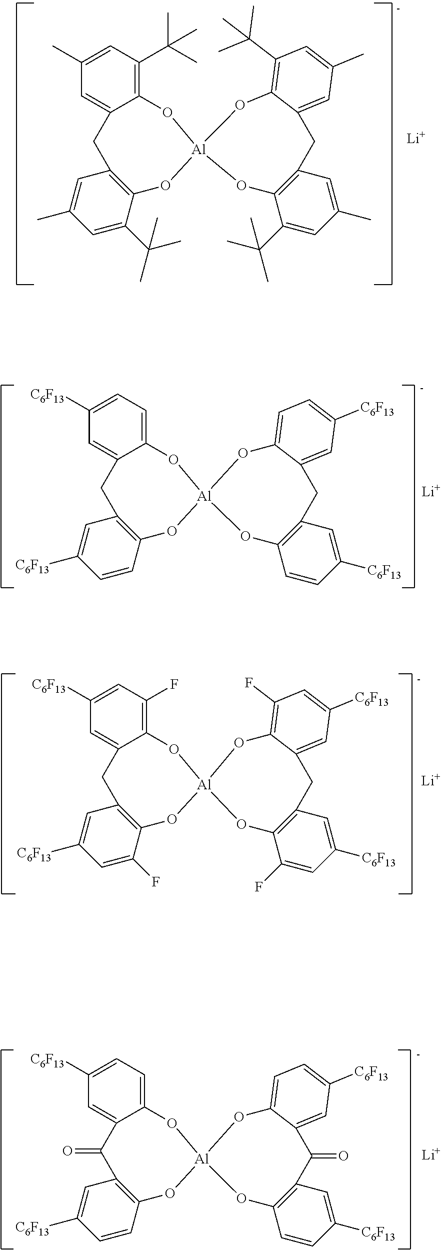

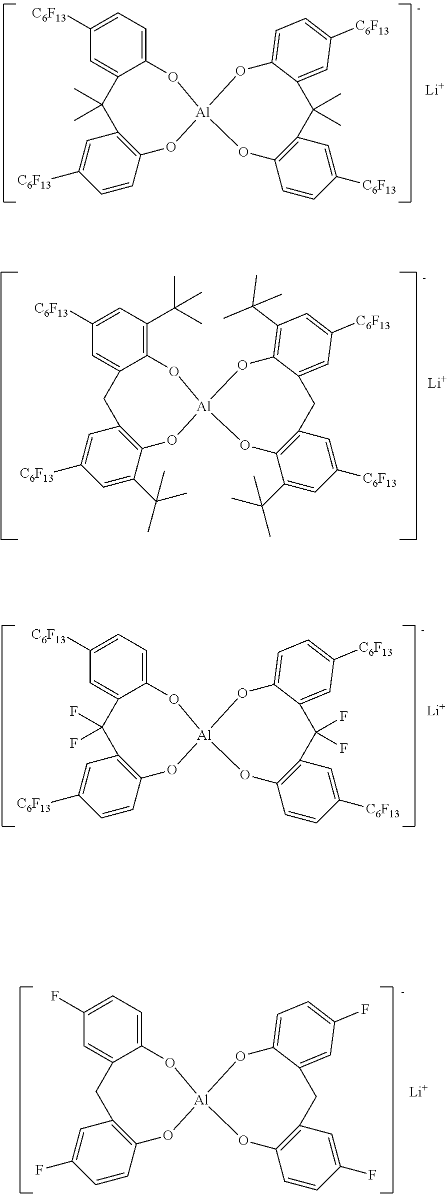

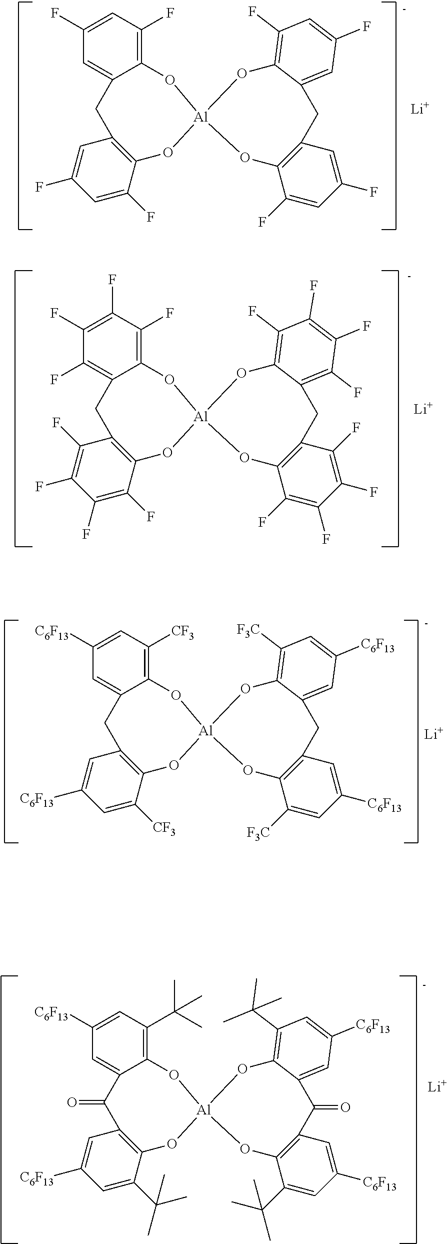

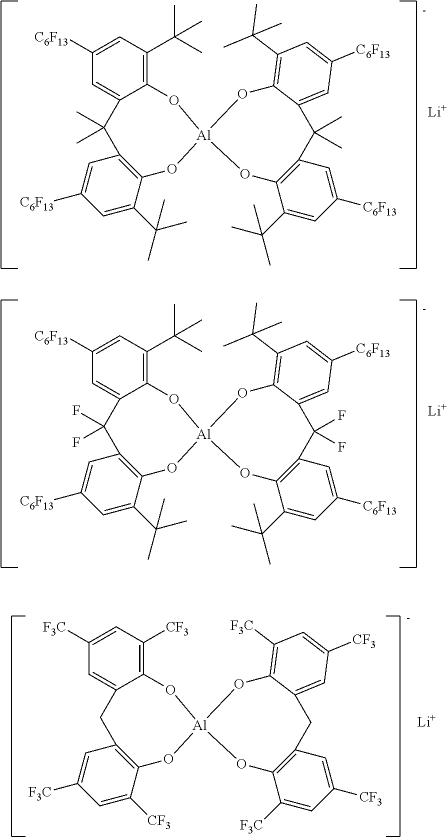

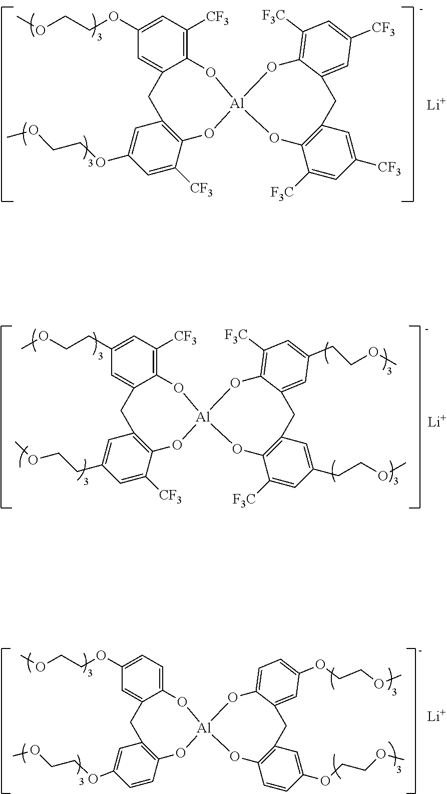

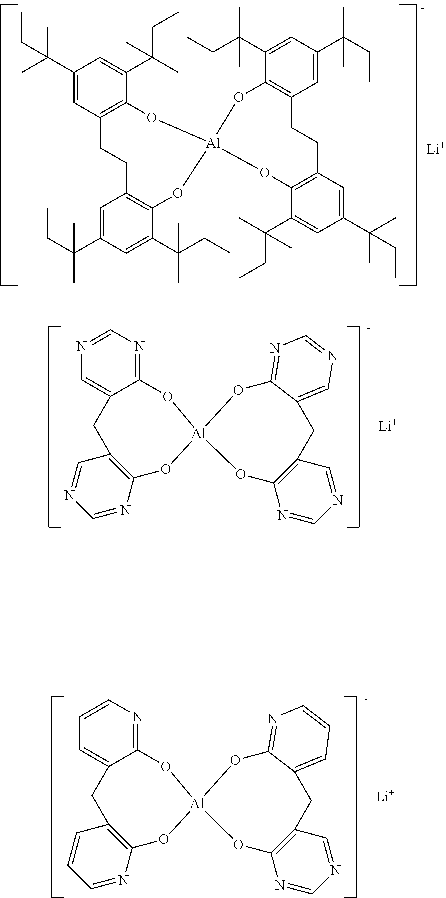

Optionally, M⁺ is a solvated cation.

Optionally the solvent of the solvate is selected from solvents comprising at least one ether group or a carbonate group.

Optionally, the compound comprises no more than 10 moles of solvate, more preferably no more than 8 moles or no more than 6 moles of solvate, per mole of M⁺. The amount of solvating solvent in a compound of formula (I) may be determined from a ¹H NMR spectrum of the compound following vacuum treatment to remove excess (non-solvating) solvent by integration of 1H NMR peaks corresponding to the solvent and peaks corresponding to the groups —O—Ar¹—Y—Ar¹—O—.

The solvent may be selected from linear and cyclic compounds containing one or more ether groups and, optionally, one or more groups selected from hydroxyl and carboxylate groups; and solvents containing carbonate groups, for example C₂₋₁₀ alkylene carbonates and di(C₁₋₁₀ alkyl) carbonates.

Exemplary solvents include, without limitation, propylene carbonate, ethylene carbonate, dimethyl carbonate, tetrahydrofuran, dimethoxyethane, diglyme (diethylene glycol dimethyl ether), triglyme (triethylene glycol dimethyl ether), tetraglyme (tetraethylene glycol dimethyl ether) and crown ethers, for example 12-Crown-4 and 1-aza-12-Crown-4.

The compound may contain more than one solvent of a solvate.

Optionally, a battery containing a compound of formula (I) contains no more than 20 moles of solvent per mole of M⁺. The presence of a small amount of solvent has been found to significantly increase the ionic conductivity of the compound of formula (I). This increase is attributed to solvation of the cation; where solvation takes place, it will be understood that M⁺ is solvated by at least some but not necessarily all of the solvent present. The presence of a small amount of organic solvent such as an ether-containing solvent or a carbonate-containing may enhance ionic conductivity whilst significantly reducing flammability as compared to an ionic compound dissolved in a large volume of such a solvent.

Accordingly, batteries containing compounds of formula (I) preferably comprise no more than 20 moles of solvent, optionally no more than 10 moles of solvent, per mole of M⁺. Preferably, the compound contains at least 0.5 moles or at least 1 mol of solvent per mole of M⁺.

A compound of formula (I) may be formed by reacting a compound of formula (II) and a compound of formula (III):

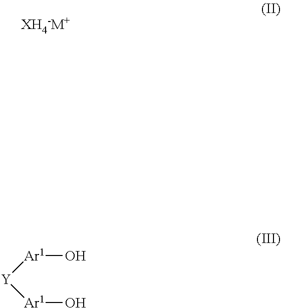

Exemplary compounds of formula (I) include, without limitation, lithium aluminium hydride (LiAlH₄), lithium borohydride (LiBH₄)

If the metal cation M⁺ is a solvated cation then in some embodiments the solvent of the solvate is present in the reaction mixture containing the compound of formula (II) and the compound of formula (III).

In some embodiments, the solvent of a compound of formula (I) containing a solvated cation may be replaced with a different solvent. Methods of changing the solvent of a solvate include, without limitation, driving off a solvent of a compound of formula (I) by heat treatment and replacing it with another solvent capable of solvating the cation; and contacting a compound of formula (I) with a solvent which coordinates more strongly to the cation than an existing solvating solvent, for example by treating a compound of formula (I) having a monodentate solvate solvent with a bi-dentate or higher-dentate solvate solvent.

### Applications

A single-ion conducting compound of formula (I) as described herein may be provided in a battery. The battery may be, without limitation, a metal battery or a metal ion battery, for example a lithium battery or a lithium ion battery.

The compound of formula (I) may be a component of a composite comprising one or more additional materials, for example one or more polymers. A composition comprising a compound of formula (I) and a polymer may form a gel.

A layer comprising or consisting of the compound of formula (I) may be formed by depositing a formulation containing the material dissolved or dispersed in a solvent or solvent mixture followed by evaporation of the solvent or solvents. Optionally, a device comprising the compound of formula (I) contains no more than 10 moles of solvent per mole of M⁺ and/or no solvent other than any solvating solvent as described herein.

The formulation may comprise a polymer additional material dissolved in the solvent or solvents.

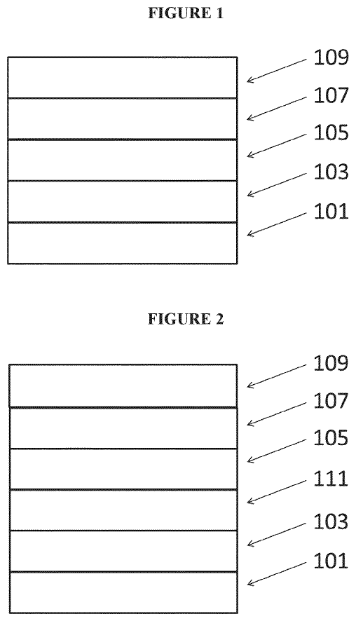

FIG. 1 illustrates a battery comprising an anode current collector 101 carrying an anode 103 on a surface thereof; a cathode current collector 109 having a cathode 107 disposed on a surface thereof; and a separator 105 disposed between the anode and cathode. The separator comprises or consists of a compound of formula (I). Preferably, the separator comprises no more than 10 moles of solvent per mole of M⁺ and/or no solvent other than any solvating solvent as described herein.

The battery may be a metal battery. The battery may be a metal ion battery.

In the case of a metal battery, the anode is a layer of metal (e.g. lithium) which is formed over the anode current collector during charging of the battery and which is stripped during discharge of the battery.

In the case of a metal ion battery, the anode comprises an active material, e.g. graphite, for absorption of the metal ions.

The cathode may be selected from any cathode known to the skilled person.

The anode and cathode current collectors may be any suitable conductive material known to the skilled person, e.g. one or more layers of metal or metal alloy such as aluminium or copper.

FIG. 1 illustrates a battery in which the anode and cathode are separated only by a separator. In other embodiments, one or more further layers may be disposed between the anode and the separator and/or the cathode and the separator.

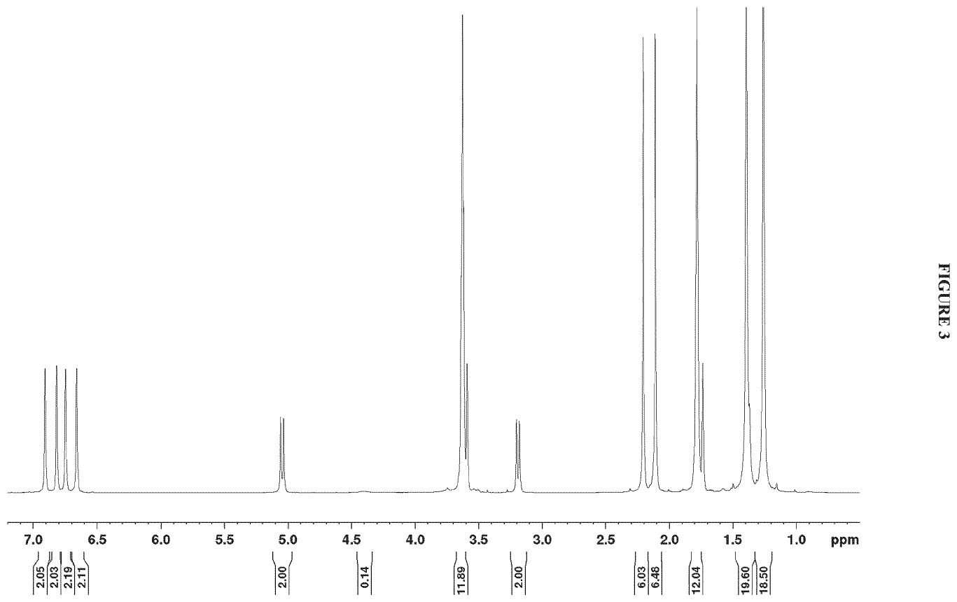

FIG. 2 illustrates a battery, preferably a metal battery, comprising an anode current collector 101 carrying an anode 103 on a surface thereof; a cathode current collector 109 having a cathode 107 disposed on a surface thereof; a separator 105 disposed between the anode and cathode; and an anode protection layer 111 disposed between anode and the separator. The separator may comprise or consist of a compound as described herein or may be any other separator known to the skilled person, for example a porous polymer having a liquid electrolyte absorbed therein. The anode protection layer comprises or consist of a compound of formula (I) as described herein. The anode protection layer may prevent or retard formation of lithium metal dendrites of a metal battery.

### EXAMPLES

### Compound Example 1

Compound Example 1 was prepared according to the following reaction scheme:

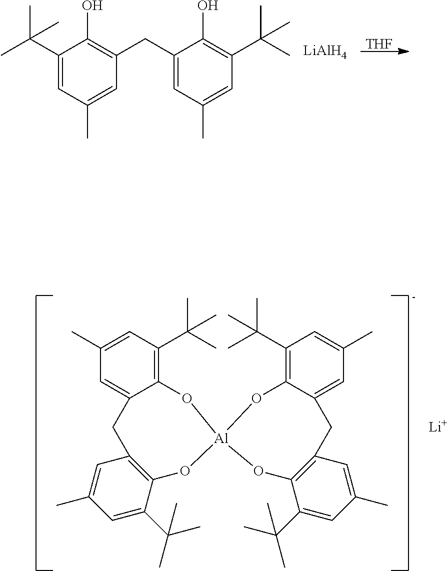

2,2′-Methylenebis(6-tert-butyl-p-cresol) (1.35 g, 3.96 mmol) was placed into a 25 ml Schlenk round-bottomed flask and dried using a trolley pump (3.2×10⁻² mmbar) at 90° C. for 2 hours. The flask was then cooled down to room temperature under nitrogen and 8 ml of anhydrous THF were added. In a separate flask, anhydrous tetrahydrofuran (2 ml) was added to a solution of lithium aluminium hydride (1.98 ml, 1.98 mmol, 1 M in THF) followed by the drop wise addition of the solution of 2,2′-Methylenebis(6-tert-butyl-p-cresol). The reaction mixture was heated to 65° C. for 1 hour and cool down to room temperature. The excess solvent was then removed under reduced pressure (3.2×10−2 mbar) at room temperature. The mixture concentrated into a thick transparent oil that crystallised over a weekend.

An NMR sample was prepared in an argon glovebox (˜20 mg of Compound Example 1 in 0.4 ml THF-d8).

¹H NMR (600 MHZ) in deuterated THF: δ (ppm), 1.25 (s, CH₃, 18H), 1.32 (s, CH₃, 18H), 1.78 (m, CH₂, from THF 25.2H), 2.10 (s, CH₃, 6H), 2.19 (s, CH₃, 6H), 3.18 (d, CH, J=14.2 Hz, 2H), 3.62 (m, CH₂ from THF, 25.2H), 5.04 (d, CH, J=14.2 Hz, 2H), 6.65 (s, CH, 2H), 6.73 (s, CH, 2H), 6.80 (s, CH, 2H), 6.89 (s, CH, 2H).

From integration of NMR peaks, it was calculated that for 2 molecules of 2,2′-Methylenebis(6-tert-butyl-p-cresol) in the product which correspond to one lithium cation, there is 6.3 molecules of THE present as residual solvent.

### Compound Example 2

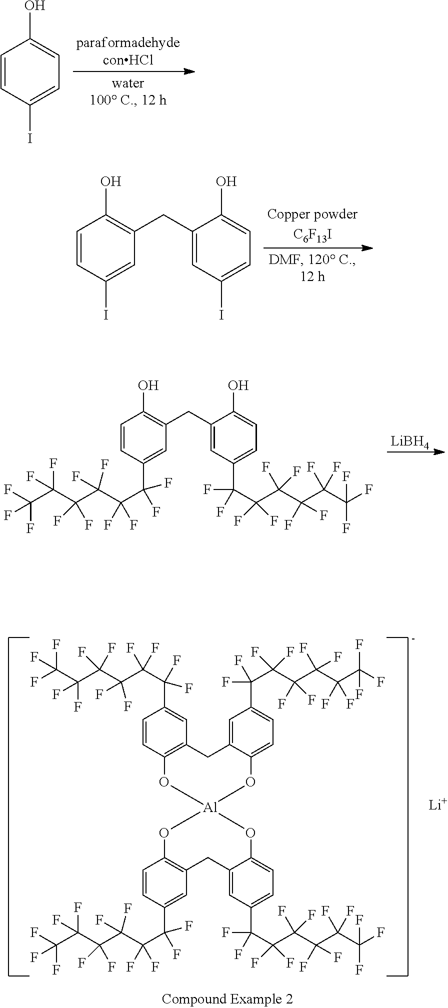

### Synthesis of 2,2′-methylenebis(4-iodophenol)

Paraformaldehyde (2.71 g, 0.090 mol) was added to a mixture of 4-iodophenol (40.0 g, 0.182 mol) in water (200 mL) and concentrated hydrochloric acid (40.0 mL) at 100° C. The mixture was stirred at 100° C. for 12 hours. The reaction mixture was cooled down to room temperature and diluted with ethyl acetate (300 mL) and water (100 mL). The aqueous layer was extracted with ethyl acetate (2×100 mL). The organic layer was then washed with water (200 mL) and brine solution (100 mL), then dried over anhydrous Na₂SO₄, filtered, and concentrated under reduced pressure. The crude product was purified by column chromatography on silica gel and eluted with a mixture of ethyl acetate and petroleum ether to give 16 g of 2,2′-methylenebis(4-iodophenol) with 68.6% LCMS purity and 3.4 g with 74.5% LCMS purity. The 3.4 g fraction was triturated with petroleum ether at 25° C. and filtered to get 3.2 g with 84.76% LCMS purity.

¹H-NMR (400 MHZ, DMSO-d6): δ [ppm] 3.9 (s, 2H), 6.65 (d, J=8.4 Hz, 2H), 7.24 (d, J=2.0 Hz, 2H), 7.32 (dd, J=2.0 Hz and 8.4 Hz, 2H), 9.73 (s, 2H)

### Synthesis of 2,2′-methylenebis(4-(perfluorohexyl)phenol)

Copper powder (24.0 g, 379 mmol) was added to a solution of 2,2′-methylenebis(4-iodophenol) (4.4 g, 9.7 mmol) and perfluorohexyl iodide (17.3 g, 38.9 mmol) in anhydrous dimethylformamide (20 mL). The mixture was stirred at 120° C. for 12 hours and cooled down to room temperature, then diluted with ethyl acetate (200 mL), filtered through celite and eluted with ethyl acetate (200 mL). The filtrate was washed with water (2×250 mL) and brine solution (100 mL). The organic layer was dried over anhydrous Na₂SO₄, filtered, and concentrated under vacuum. The crude product (6.4 g) was purified by column chromatography on silica gel. Fractions containing the product were combined, concentrated to dryness under reduced pressure and the residue was triturated with petroleum ether to get two fractions. Both fractions were separately taken for GPC purification to get 1.9 g of the desired product. It was further purified again by column chromatography to yield 1.8 g of 2,2′-methylenebis(4-(perfluorohexyl)phenol) with 98.54% HPLC purity, 22% yield.

¹H-NMR (400 MHz, DMSO-d6): δ [ppm] 3.9 (s, 2H), 7.02 (d, J=8.4 Hz, 2H), 7.07 (d, J=1.6 Hz, 2H), 7.33 (dd, J=1.6 Hz and 8.4 Hz, 2H), 10.42 (s, 2H)

### Synthesis of Compound Example 2

To a solution of lithium aluminium hydride (2 ml, 0.5 M in THF) was added drop wise a solution of 2,2′-methylenebis(4-(perfluorohexyl)phenol) (1.8 g, 2.15 mmol) in THF (5 ml) at room temperature. The solution was heated to 60° C. for 1 hour and cooled down to room temperature and propylene carbonate (0.36 ml) was added. The excess solvent was then removed under reduced pressure at 25° C., under 3.5×10⁻² mbar. During concentration a very viscous oil formed. Propylene carbonate and 1,2-dimethoxyethane were added to it but the oil didn't dissolve. The supernatant was removed under nitrogen and THF was added to the residue to obtain a viscous oil.

From integration of NMR peaks, it was calculated that for two molecules of 2,2′-methylenebis(4-(perfluorohexyl)phenol) corresponding to one molecule of lithium cation, there are 2.3 molecules of THE, 6.6 molecules of propylene carbonate (PC) and 2.2 molecules of, 2-dimethoxyethane.

### Stability

In a glovebox filled with argon, 40 mg of Compound Example 1 were placed into 2 ml glass vials. The vials were placed on a hotplate with an aluminium hot-block set at 50° C. for 16 hours. A control experiment was done using Comparative Compound 1 (45-50 mg/sample).

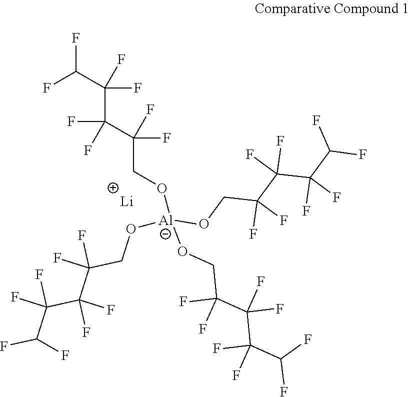

The samples were exposed to the air in the laboratory having a relative air humidity of 43% and a temperature of 22° C.

Hydrolysis was monitored by ¹H NMR (600 MHz) in THF-d8.

All NMR samples were prepared in the same glovebox, by dissolving the compounds in the vials with 0.4 ml of THF-d8.

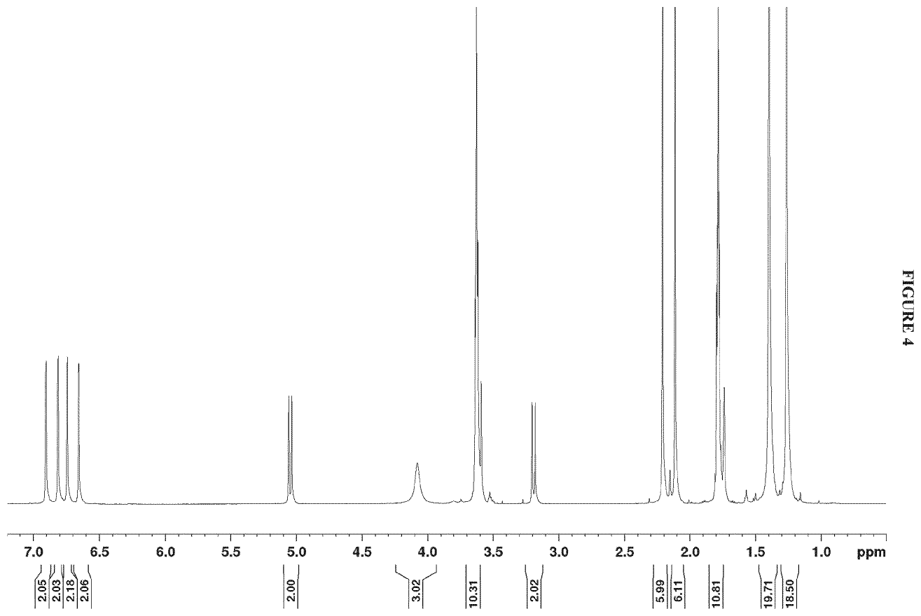

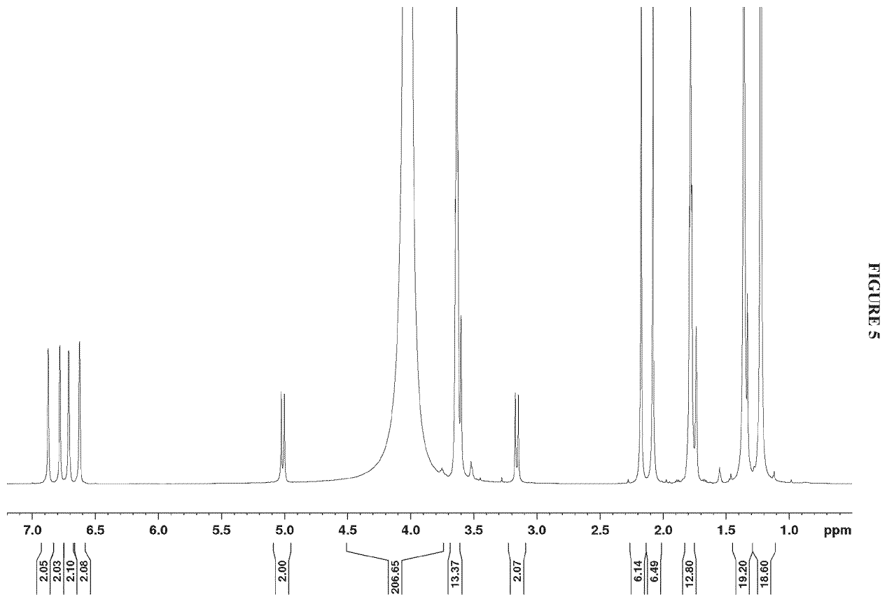

FIGS. 3, 4 and 5 are ¹H NMR spectra of Compound Example 1 respectively after drying, after exposing the dried sample to moist air with relative humidity at 43% at 22° C. for 90 minutes and adding to the solution of dried sample in THF-d8 one drop of water.

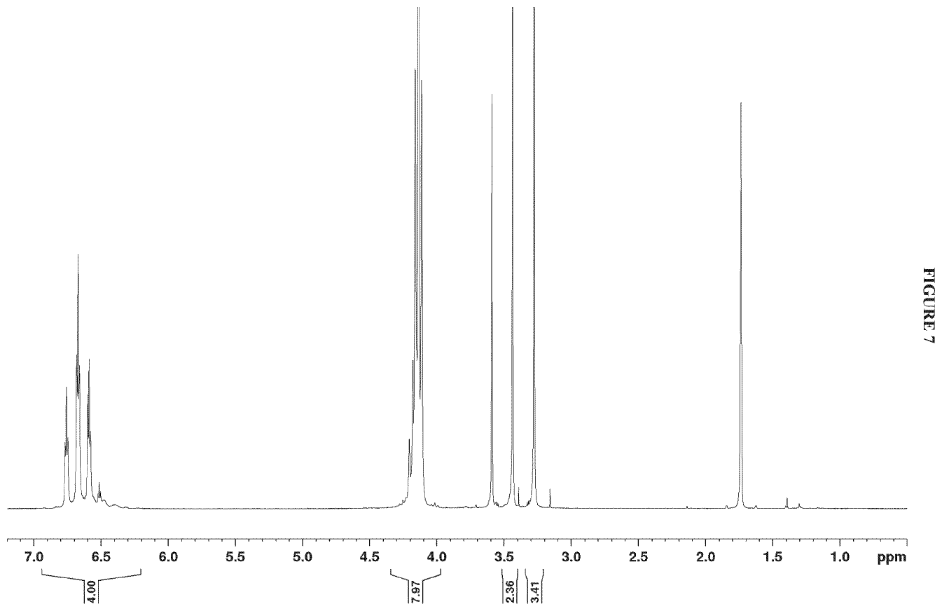

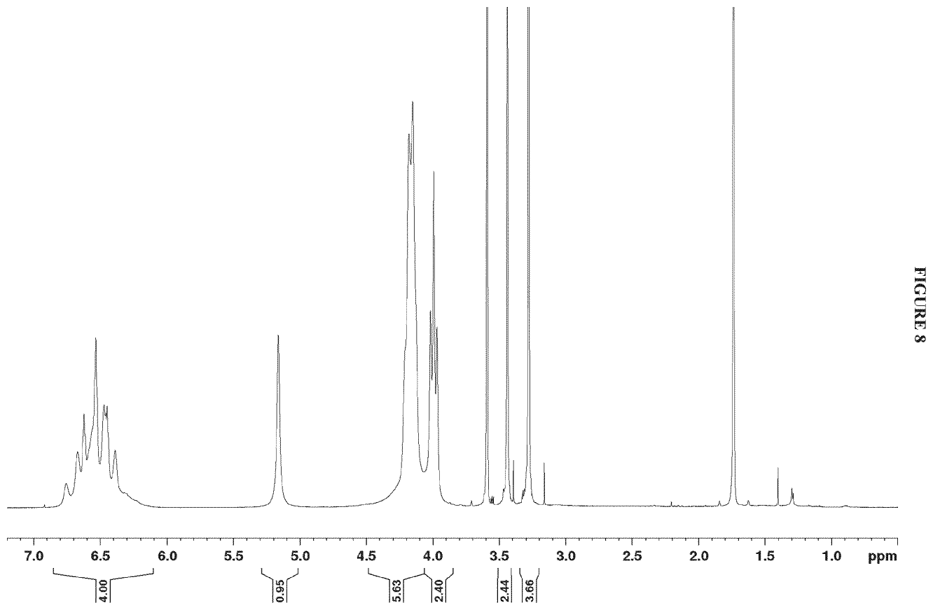

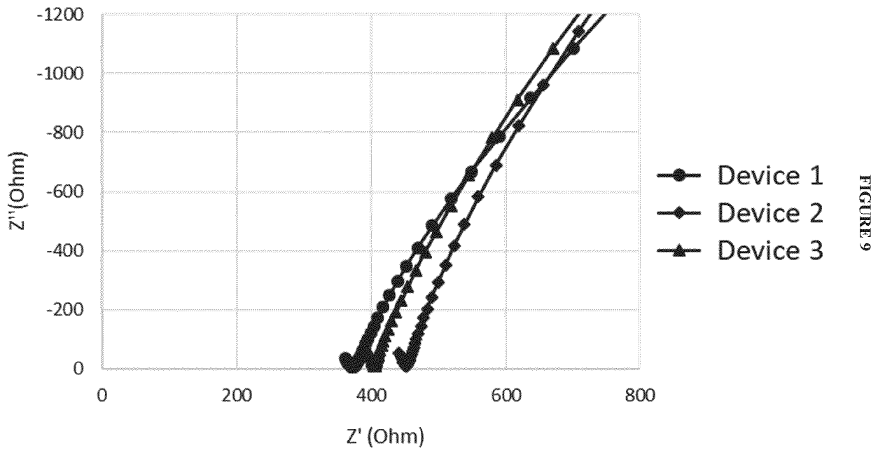

The only change between these three spectra is the integration of the peak associated to water at 4.1 ppm. It is confirmed by the Diffusion Ordered Spectroscopy spectrum of FIG. 6 that this peak at 4.1 ppm is not related to hydrolysis of Compound Example 1. All the peaks associated with Compound Example 1 diffuse with log (−9.2 to −9.6) m²/s while the peak with chemical shift at 4.1 ppm diffuses with similar rate to the THF-d8 with log (−8.6 to −8.8) m²/s.

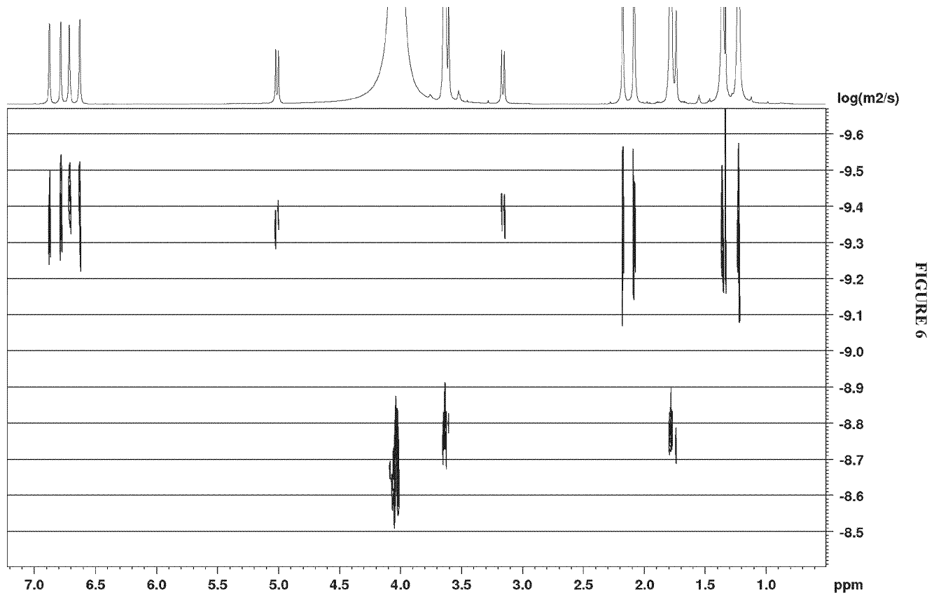

FIGS. 5 and 6 are, respectively, the ¹H NMR spectra of Comparative Compound 1 after drying, and after exposing the dried sample to moist air with relative humidity at 43% at 22° C. for 40 minutes.

FIG. 6 has additional peaks to those present in FIG. 5: δ (ppm), 4.00 (t, CF₂CH₂, J=14.4 Hz, 2.4H), 5.16 (s, OH, 0.95) furthermore the triplet of triplet δ=6.65 ppm has become a multiplet δ=6.53 ppm and the triplet δ=4.13 ppm has become a multiplet δ=4.16 ppm. These changes are attributed to dissociation of 2,2,3,3,4,4,5,5-octafluoro-1-pentanol from Comparative Compound 1.

### Electrolyte Solution

Solutions of Compound Example 1 were prepared in a glovebox filled with argon. The solid was suspended into propylene carbonate as set out in Table 1 and mixtures were stirred on a hotplate at 50° C. until the solid was fully dissolved. Concentrations were calculated using the molecular weight of the lithium salt with the residual THF solvent.

TABLE 1

| Amount of | Volume of | | Molecules | Molecules of |
|---|---|---|---|---|
| Compound | propylene | | of THF | propylene |
| Example 1 | carbonate | Concentration | per Li⁺ | carbonate per |
| (mg) | (ml) | (mol/L) | cation | Li⁺ cation |
| 582.6 | 0.5 | 1.0 | 4.7 | 11.1 |
| 233.0 | 0.1 | 2.0 | 4.9 | 5.8 |
| 349.6 | 0.1 | 3.0 | 4.5 | 3.7 |

### Electrochemical Impedance Spectroscopy (EIS)

Measurements were performed on 2032-type coin cells (Cambridge Energy Solutions).

The cells were fabricated by inserting a stainless steel spacer in the coin cell bottom, followed by a fluoro-silicone stencil. The stencil was shaped as a disk of diameter 155 mm, with a circular hole of diameter 5 mm cut in its middle. 30 μl of electrolyte solution were filled into the hole. On top of the stencil two stainless steel spacers were placed, plus a wave spring and the coin cell top, followed by crimping. The thickness of the stencil in the crimped cell was 360 μm.

All the cells were assembled in an Argon-filled glovebox (MBraun).

EIS measurements were conducted at room temperature. The EIS measurements were taken over a frequency range of 1 Hz to 1 MHz with an amplitude of 5 mV.

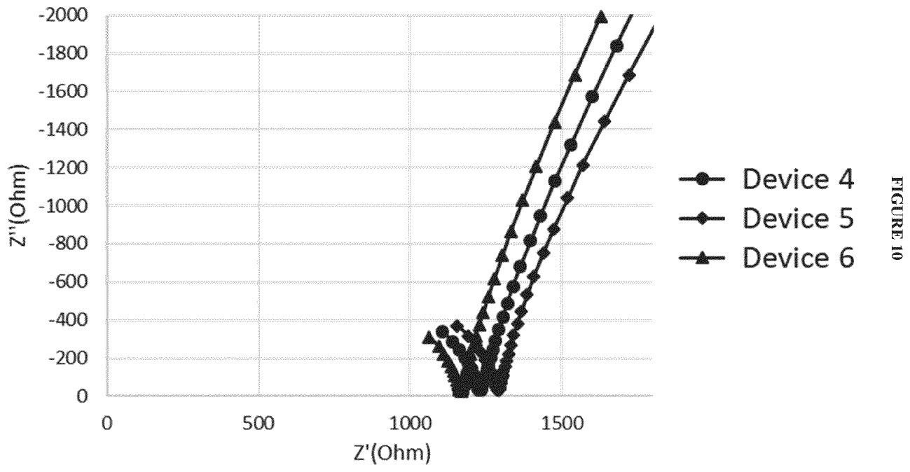

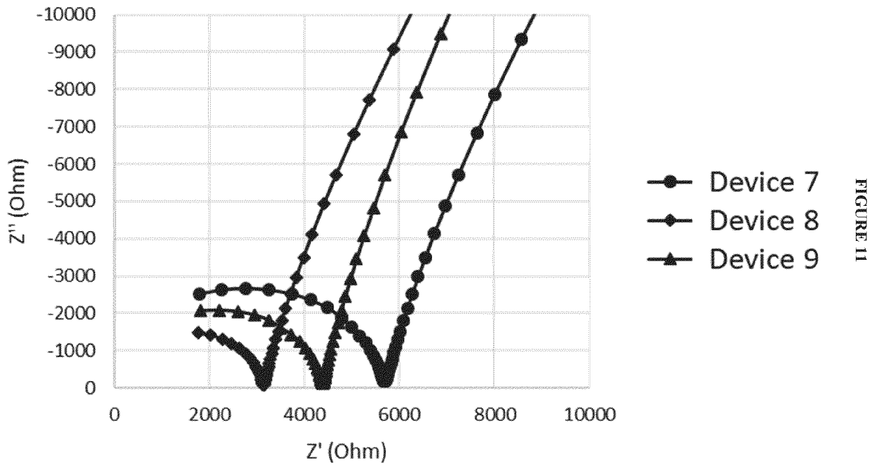

Ionic conductivities were calculated using the following formula:

$$σ = \frac{l}{A \cdot R}$$

where l is the thickness of the material between the two stainless disks which corresponds to the fluorinated separator thickness once crimped thickness (360 μm), A is the area of the hole in the separator and R is the impedance. The impedance of the cell was determined by estimating the intercept on the x-axis of the Nyquist plot (FIGS. 9 to 11). The average conductivity reported in Table 2 is the average of the conductivities calculated for 3 devices.

TABLE 2

| | | Average |
|---|---|---|
| | Compound 1 concentration in | conductivity |
| Devices | propylene carbonate | (S/cm) |
| 1-3 | 1M | 4.5 × 10⁻⁴ |
| 4-6 | 2M | 1.5 × 10⁻⁴ |
| 7-9 | 3M | 4.4 × 10⁻⁵ |

1. A metal battery or metal ion battery comprising an anode, a cathode and a compound of formula (I) disposed between the anode and the cathode: 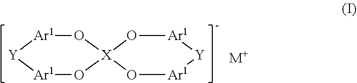
wherein X is Al or B; Ar¹ in each occurrence is independently an unsubstituted or substituted arylene or heteroarylene group; Y is a divalent group; and M⁺ is a cation.

2. The battery according to claim 1 wherein Ar¹ in each occurrence is independently a phenylene.

3. The battery according to claim 2 wherein Ar¹ in each occurrence is a 1,2-linked phenylene.

4. The battery according to claim 1 wherein one or more Ar¹ groups are substituted with at least one substituent R¹ selected from C₁₋₂₀ alkyl wherein one or more non-adjacent C atoms of the alkyl group may be replaced with O, S, NR³, CO, or COO wherein R³ is H or a substituent and one or more H atoms of the alkyl group may be replaced with F.

5. The battery according to claim 1 wherein Y is selected from O, S, NR³, C═O, CR²₂ and a branched or linear C₂₋₁₀ alkylene group wherein one or more non-adjacent C atoms may be replaced with O, S, NR³, CO or COO, wherein R² in each occurrence is independently H, F or a C₁₋₁₂ alkyl wherein one or more non-adjacent, non-terminal C atoms may be replaced with O, S, CO or COO and R³ in each occurrence is H or a substituent and one or more H atoms of the alkyl group may be replaced with F.

6. The battery according to claim 1 wherein M⁺ of the compound of formula (I) is an alkali metal ion.

7. The battery according to claim 6 wherein M⁺ is a lithium ion.

8. The battery according to claim 1 wherein M⁺ is a solvated cation.

9. The battery according to claim 8 wherein the solvate is selected from solvents comprising at least one ether group and solvents comprising a carbonate group.

10. The battery according to claim 1 wherein the battery comprises no more than 20 moles of solvent per mole of M⁺.

11. The battery according to claim 1 wherein the battery is a metal battery.
